(19) United States
(12) Patent Application Publication
(10) Pub. No.: US 2013/0272234 A1
(43) Pub. Date: Oct. 17, 2013

(54) METHOD AND APPARATUS FOR INTERPRETING CONTENT OF A DOWNLINK RESOURCE ALLOCATION FIELD IN A USER EQUIPMENT (UE) IN A WIRELESS COMMUNICATION NETWORK

(71) Applicant: INNOVATIVE SONIC CORPORATION, Taipei City (TW)

(72) Inventor: Richard Lee-Chee Kuo, Taipei City (TW)

(73) Assignee: Innovative Sonic Corporation, Taipei City (TW)

(21) Appl. No.: 13/862,965

(22) Filed: Apr. 15, 2013

Related U.S. Application Data
(60) Provisional application No. 61/624,596, filed on Apr. 16, 2012.

(51) Int. Cl. H04W 72/04

(52) U.S. Cl. CPC H04W 72/042
USPC 370/329

(57) ABSTRACT

A method and apparatus are disclosed for interpreting content of a downlink resource allocation field in a UE (User Equipment) that is served by a backward compatible carrier. The method includes receiving an RRC message to configure a new carrier to the UE, wherein the new carrier is associated with the backward compatible carrier. The method further includes marking a first time instant when a specific signaling associated with the new carrier is received by the UE. The method also includes determining a second time instant based on the first time instant. In addition, the method includes starting to interpret, at the UE, content of a downlink resource allocation field based on both a downlink bandwidth of the backward compatible carrier and a downlink bandwidth of the new carrier at the second time instant, wherein the downlink resource allocation field is included in a PDCCH (Physical Downlink Control Channel) addressed to the backward compatible carrier.

### CROSS-REFERENCE TO RELATED. APPLICATIONS

The present Application claims the benefit of U.S. Provisional. Patent Application Ser. No. 61/624,596 filed on Apr. 16, 2012, the entire disclosure of which is incorporated herein by reference.

### FIELD

This disclosure, generally relates to wireless communication networks, and more particularly, to a method, and apparatus for interpreting content of a downlink resource allocation field in a UE (User Equipment).

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services, The E-UTRAN system's standardization work is currently being performed by the 3GPP standards organization. Accordingly, changes to the current body of 3GPP standard are currently being submitted and considered to evolve and finalize the 3GPP standard.

### SUMMARY

A method and apparatus are disclosed for interpreting content of a downlink resource allocation field in a UE (User Equipment) that is served by a backward compatible carrier. The method includes receiving an RRC message to configure a new carrier to the UE, wherein the new carrier is associated with the backward compatible carrier. The method further includes marking a first time instant, when a specific signaling associated with the new carrier is received by the UE. The method also includes determining a second time instant based on the first time instant. In addition, the method includes starting to interpret, at the UE, content of a downlink resource allocation field based on both a downlink bandwidth of the backward compatible carrier and a downlink bandwidth of the new carrier at the second time instant, wherein the downlink resource allocation field is included in a PDCCH (Physical Downlink Control. Channel) addressed to the backward compatible carrier.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a, functional block diagram of a communication system according to one exemplary embodiment.

FIG. 4 is a functional block diagram of the program code of FIG. 3 according to one exemplary embodiment.

FIG. 5 is a message sequence chart according to one exemplary embodiment.

### DETAILED DESCRIPTION

The exemplary wireless communication, systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LIE (Long Term Evolution) wireless access, 3GPP LTE-A or LTE-Advanced (Long Term Evolution. Advanced), 3GPP2 UMB (Ultra Mobile Broadband), WiMax, or some other modulation techniques.

In particular, the exemplary wireless communication systems devices described below may be designed to support one or more standards such as the standard offered by a consortium named “3rd Generation Partnership Project” referred to herein as 3GPP, including Document Nos, R1-100038, “On definitions of carrier types”; TS 36.331 V10, 5.0, “E-UTRA RRC protocol specification (Release 10)”; TS 36.213-a40, “E-UTRA Physical layer procedures (Release 10)”; TS 36.212-a40, “T-UTRA Multiplexing and channel coding (Release 10)”. The standards and documents listed above are hereby expressly incorporated herein.

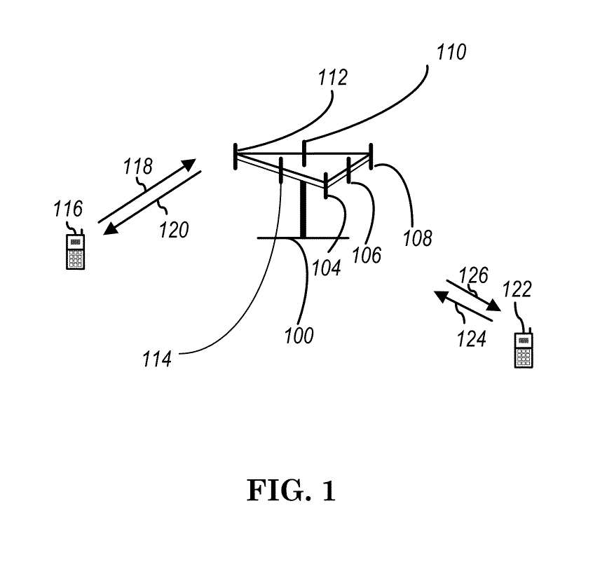

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station. eNodeB, or some other terminology. An access terminal (AT) may also be called user equipment (UE), a wireless communication device, terminal, access terminal or some other terminology.

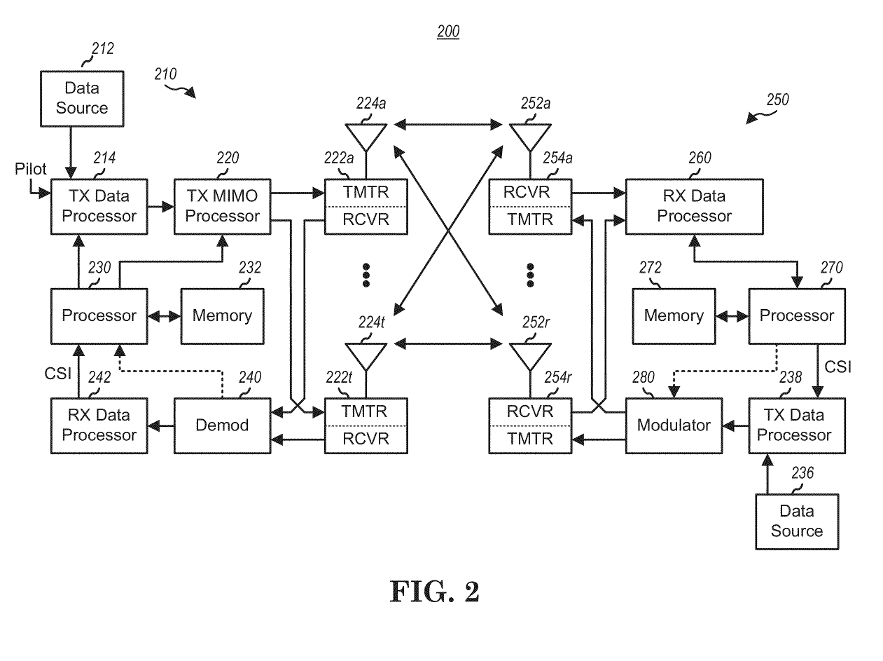

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna, TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot, and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g. amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received, signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

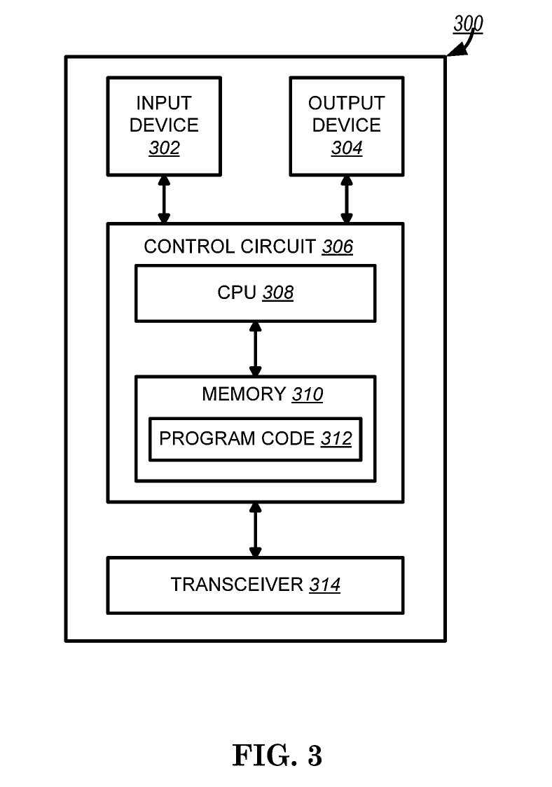

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

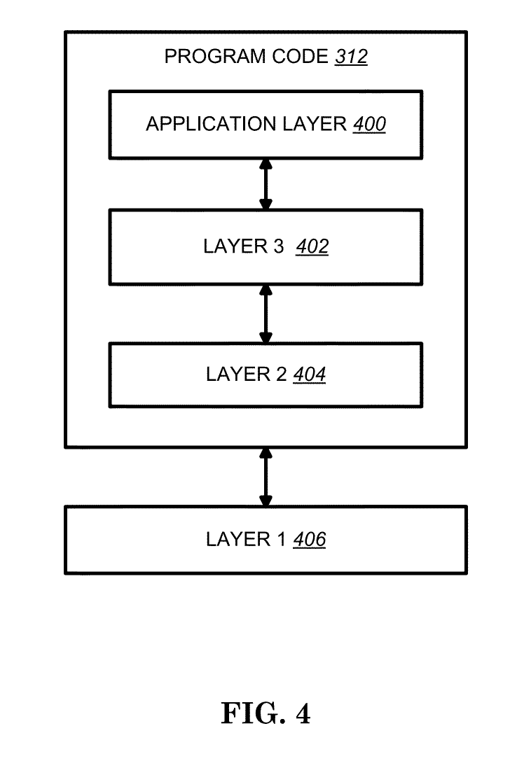

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

In Rel-10 discussions, 3GPP R1-100038 introduces two additional carrier types, including extension carrier and carrier segment. In addition, 3GPP R1-100038 describes the properties of these two additional carrier types as follows:

Properties of extension carriers

Supported by carrier aggregation
Non-backwards compatible carrier
Transmission bandwidth is at least from the set of existing values, i.e.,
{6, 15, 25, 50, 75, 100} RBs. Other transmission bandwidths
may be defined by RAN4.
The sum of backward compatible component carrier and extension carrier
can be more than 110 RBs.
Separate PDCCH indicates the RBs defined within the extension carrier.
It is FFS whether the linkage between backward compatible component
carrier and extension carrier is per UE.
Separate HARQ process running within an extension carrier.
Backward compatible component carrier (to which the extension carrier is
linked to) and the extension carrier can be configured with different
transmission modes.
Extension carriers configuration without CRS is FFS.
Extension carriers can be configured as contiguous or as non-contiguous to
the backwards compatible component carrier they are linked to.

Properties of carrier segments:

Not necessary to have carrier aggregation.
Used to enable additional transmission bandwidths beyond the set of Rel-8
values, i.e., {6, 15, 25, 50, 75, 100} RBs but no more than
110 RBs. What sets are used is defined by RAN4.
The sum of backward compatible component carrier and segment(s) shall
be no more than 110RBs. Configurations with sum of backwards
compatible component carrier and segment(s) over 110RBs are FFS.
One PDCCH indicates the RBs allocated in the sum of backward
compatible carrier and segment(s).
One HARQ process for the sum of backward compatible carrier and
segment(s).
Backward compatible component carrier and segment(s) use the same
transmission mode.
Segments configuration without CRS is FFS.
Segments are contiguous to the component carrier they are associated
with.

Discussions on the additional carrier types were postponed to Rel-11 due to time limit in Rel-10. In the RAN1#66bis meeting, it was concluded that at least one new carrier type in Rel-11 should be introduced due to certain motivation factors, including: energy efficiency, enhanced spectral efficiency, and improved support for HetNet (Heterogenous Network). The new carrier type should be associated with a backward compatible carrier and should be applied at least for the downlink.

In the RAN1#67 meeting, it was further agreed to support synchronized carriers and unsynchronized carriers as follows:

Synchronized carriers, where the legacy and the additional carnets are synchronized in time and frequency to the extent that no separate synchronization processing is needed in the receiver; and

Unsynchronized carriers, where the legacy and the additional carriers are not synchronized with the same degree of accuracy as for the synchronized carriers. As described above, there are two types of additional carriers: extension carrier and carrier segment.

It was then concluded in the RAN1#68bis meeting that Rel-8 PSS/SSS sequences are transmitted at least for the unsynchronized case. Furthermore, it was noted in the RAN1#68bis minutes that resource allocation for the new carrier type has not been covered so far. Therefore, some changes to the resource allocation, are needed for support of the new carrier type.

According to section 7.1.6 in 3GPP TS 36.213-a40, how a UE interprets the content of the resource allocation field included in a Rel-10 PDCCH would depend on the downlink system bandwidth (i.e., N_{RB}^{DL}) of the relevant serving cell. After a carrier segment is introduced in Rel-11, a PDCCH (Physical Downlink Control Channel) will be used to indicate the resource blocks (RBs) allocated, in the sum of the backward compatible carrier and the carrier segment.

Although the resource allocation process for the new carrier type has not been decided, it would be likely that the downlink system bandwidths of both the backward compatible carrier and the carrier segment would need to be taken into consideration when the UE interprets the content of the resource allocation field. For example, the summation of the downlink system bandwidths of both the backward compatible carrier and the carrier segment may be used to interpret a downlink resource allocation field.

From a performance perspective, there would a need to synchronize the timings of changing the value of downlink system bandwidth used for interpreting the content of the resource allocation field in both UE and eNB once a carrier segment is configured to the UE. Otherwise, if the timings are not synchronized, the UE may not be able to interpret the resource allocation field correctly and decode the downlink transmission successfully at least for certain period of time after the carrier segment is configured or activated to the UE. In addition, the bit length of the resource allocation field would also be determined with the allocated downlink system bandwidth according to Section 533.1 of 3GPP TS 36.212-a40. Synchronization for determining bit length of the resource allocation field would also be needed.

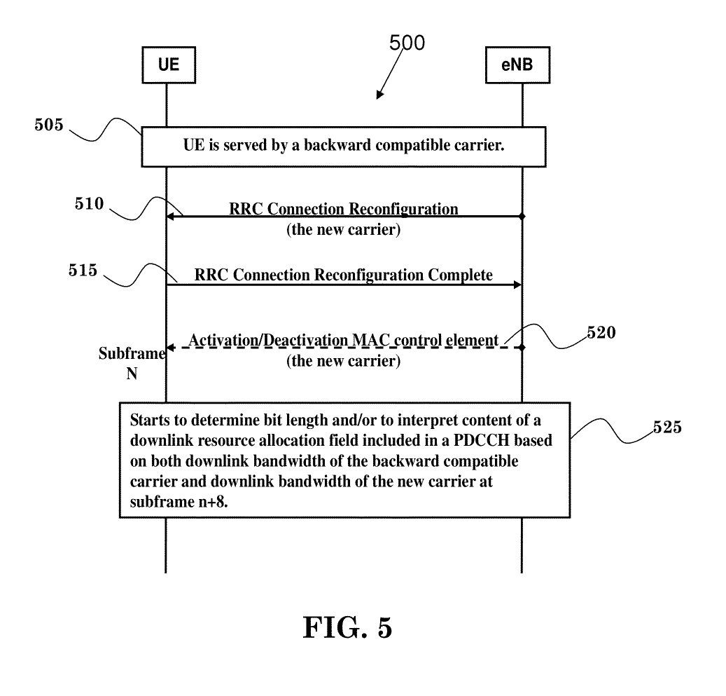

FIG. 5 is a message sequence chart 500 in accordance with one exemplary embodiment. As shown in box 505, the UE is served by a backward compatible carrier. In step 510, the eNB sends a RRC (Radio Resource Control) Connection Reconfiguration message to the UE for configuring a new carrier to the UE. In response to the RRC Connection Reconfiguration message, the LTE sends a RRC Connection. Reconfiguration Complete message to the eNB in step 515. In step 520, the UE receives an Activation/Deactivation MAC (Medium Access Control) control element to the LTE at subframe N for activating the new carrier. In the exemplary embodiment shown in step 525, the UE starts to determine the bit length of and/or to interpret the content of a downlink resource allocation field that is included, in the PDCCH based on both the downlink bandwidth of the backward compatible carrier and the downlink bandwidth of the new carrier at subframe N+8, Within the eight (8) subframes, the UE retunes the bandwidth of a radio frequency (RF) receiver in the UE for accommodating the new carrier. The eight (8) subframes is merely an example. The number of subframes could be a different number depending on the UP hardware capability (e.g., how fast the UP could finish RF returning).

Referring back to FIGS. 3 and 4, the device 300 includes a program code 312 stored in memory 310. In one embodiment, the CPU 308 could execute the program code 312 (i) to receive an RRC message for configuring a new carrier to the UE, wherein the new carrier is associated with the backward compatible carrier, (ii) to mark a first time instant when a specific signaling associated with the new carrier is received by the UE, (iii) to determine a second time instant based on the first time instant, and (iv) to start to interpret, at the UE, content of a downlink resource allocation field based on both a downlink bandwidth of the backward compatible carrier and a downlink bandwidth of the new carrier at the second time instant, wherein the downlink resource allocation field is included in a PDCCH (Physical Downlink Control Channel) addressed to the backward compatible carrier.

In one embodiment, the specific signaling is an Activation/Deactivation MAC control element associated with the new carrier and the first time instant is marked when the UE receives the Activation/Deactivation MAC control element. Furthermore, the second time instant is eight (8) subframes after the first time instant.

In another embodiment, the UE interprets the content of the downlink resource allocation field based on the downlink bandwidth of the backward compatible carrier before the second time instant. In this embodiment, the UE starts to determine a bit length of the downlink resource allocation field based on both the downlink bandwidth of the backward compatible carrier and the downlink bandwidth of the new carrier at the second time instant. In addition, determines the bit length of the downlink resource allocation field based on the downlink bandwidth of the backward compatible carrier before the second time instant.

In one embodiment, the new carrier could be a carrier segment or a downlink carrier. Furthermore, the new carrier is contiguous to the backward compatible carrier. In addition, a PDCCH could be used to indicate resource blocks (RBs) allocated for both the backward compatible carrier and the new carrier. Furthermore, a HARQ (Hybrid Automatic Repeat and Request) process could be used to handle a transport block received from resource blocks (RBs) allocated for both the backward compatible carrier and the new carrier.

In addition, the CPU 308 can execute the program code 312 to perform all of the above-described actions and steps or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different, technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within, the known and customary practice within the art to which the invention pertains.

What is claimed:

1. A method for interpreting content of a downlink resource allocation field in a UE (User Equipment) that is served by a backward compatible carrier, comprising:
receiving an RRC message to configure a new carrier to the UE, wherein the new carrier is associated with the backward compatible carrier;
marking a first time instant when a specific signaling associated with the new carrier is received by the UE;
determining a second time instant based on the first time instant; and
starting to interpret, at the UE, content of a downlink resource allocation, field based on both a downlink bandwidth of the backward compatible carrier and a downlink bandwidth of the new carrier at the second time instant,
wherein the downlink resource allocation field is included in a PDCCH (Physical Downlink Control Channel) addressed to the backward compatible carrier.

2. The method of claim 1, wherein the specific signaling is an Activation/Deactivation MAC control element associated with the new carrier and the first time instant is marked when the UE receives the Activation/Deactivation MAC control element.

3. The method of claim 1, wherein the second time instant is eight (8) subframes after the first time instant.

4. The method of claim 1, wherein the UE interprets the content of the downlink resource allocation field based on the downlink bandwidth of the backward compatible carrier before the second time instant.

5. The method of claim 1, wherein the UE starts to determine a bit length of the downlink resource allocation field based on both the downlink bandwidth of the backward compatible carrier and the downlink bandwidth of the new carrier at the second time instant.

6. The method of claim 5, wherein the UE determines the bit length of the downlink resource allocation field based on the downlink bandwidth of the backward compatible carrier before the second time instant.

7. The method of claim 1, wherein the new carrier could be a carrier segment or a downlink carrier.

8. The method of claim 1, wherein the new carrier is contiguous to the backward compatible carrier.

9. The method of claim 1, wherein one PDCCH is used to indicate resource blocks (RBs) allocated for both the backward compatible carrier and the new carrier.

10. The method of claim 1, wherein one HARQ (Hybrid Automatic Repeat and Request) process is used to handle a transport block received from resource blocks (RBs) allocated for both the backward compatible carrier and the new carrier.

11. A communication device for interpreting content of a downlink resource allocation field in a UE (User Equipment) that is served by a backward compatible carrier, the communication device comprising:
a control circuit;
a processor installed in the control circuit;
a memory installed in the control circuit and operatively coupled to the processor;
wherein the processor is configured to execute a program code stored in memory to logging instances of a UE (User Equipment) failing to establish connection by;
receiving an RRC message to configure a new carrier to the UE, wherein the new carrier is associated with the backward compatible carrier;
marking a first time instant when a specific signaling associated with the new carrier is received by the UE;
determining a second time instant based on the first time instant; and
starting to interpret, at the UE, content of a downlink resource allocation field based on both a downlink bandwidth of the backward compatible carrier and a downlink bandwidth of the new carrier at the second time instant,
wherein the downlink resource allocation field is included in a PDCCH (Physical Downlink Control Channel) addressed to the backward compatible carrier.

12. The communication device of claim 11, wherein the specific signaling is an Activation/Deactivation MAC control element associated with the new carrier and the first time instant is marked when the UE receives the Activation/Deactivation MAC control element.

13. The communication device of claim 11, wherein the second time instant is eight (8) subframes after the first time instant.

14. The communication device of claim 11, wherein the UE interprets the content of the downlink resource allocation field based on the downlink bandwidth of the backward compatible carrier before the second time instant.

15. The communication device of claim 11, wherein the UE starts to determine a bit length of the downlink resource allocation field based on both the downlink bandwidth of the backward compatible carrier and the downlink bandwidth of the new carrier at the second time instant.

16. The communication device of claim 15, wherein, the UE determines the bit length, of the downlink resource allocation field based on the downlink bandwidth of the backward compatible carrier before the second time instant.

17. The communication device of claim 11, wherein the new carrier could be a carrier segment or a downlink carrier.

18. The communication device of claim 11, wherein the new carrier is contiguous to the backward compatible cattier.

19. The communication device of claim 11, wherein one PDCCH is used to indicate resource blocks (RBs): allocated for both the backward compatible carrier and the new carrier.

20. The communication device of claim 11, wherein one HARQ (Hybrid Automatic Repeat and Request) process is used to handle a transport block received from resource blocks (RBs) allocated for both the backward compatible carrier and the new carrier.
